(19) United States
(12) Patent Application Publication
(10) Pub. No.: US 2010/0321328 A1
(43) Pub. Date: Dec. 23, 2010

(54) COORDINATES ALGORITHM AND POSITION SENSING SYSTEM OF TOUCH PANEL

(75) Inventors: Hui-Hung CHANG, Keelung City (TW); Meng-Hsiu Wu, Hsinchu City (TW); Chun-Ching Huang, Hsinchu City (TW); Chun-Hung Chen, Hsinchu City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/649,104

(22) Filed: Dec. 29, 2009

(30) Foreign Application Priority Data
Jun. 17, 2009 (TW) 98120310

(51) Int. Cl. G06F 3/044

(52) U.S. Cl. 345/174

(57) ABSTRACT

A position sensing system of a touch panel including a sensing unit and a decision unit is provided. When the touch panel is touched, the sensing unit obtains the sensing capacitances of p x-directional sensing lines and q y-directional sensing lines, wherein the sensing capacitances generated by these sensing lines exceed a threshold. The decision unit takes the central coordinates of the sensing lines with peak sensing capacitances as an x base coordinate and a y base coordinate, and adjusts the x base coordinate and the y base coordinate according to the ratios of the sensing capacitances of the other sensing lines to the peak sensing capacitance respectively to obtain an interpolated x coordinate and an interpolated y coordinate.

This application claims the benefit of Taiwan application Serial No. 98120310, filed Jun. 17, 2009, the subject matter of which is incorporated herein by reference.

### BACKGROUND OF THE INVENTION

1. Field of the Invention

The invention relates in general to a coordinate algorithm and a position sensing system of a touch panel, and more particularly to a coordinate algorithm and a position sensing system of a touch panel which can be implemented by hardware for increasing the resolution of the touch panel.

2. Description of the Related Art

As the demand for the multi-touch technology increases, the projected capacitive touch technology has become one of the mainstream technologies of touch panel. Owing to the fact that the human body is an excellent conductor, if the human body nears the projected capacitive touch panel, the capacitance generated due to the electrostatic coupling between the transparent electrode (ITO) of the projected capacitive touch panel and the human body increases. The position of the touched point can be obtained by checking the capacity change in the static electricity of the sensing lines on the projected capacitive touch panel.

In order to sense enough human body capacitance, the projected capacitive touch panel needs to consider the size of the sensing pad, and due to the limitation on the sensing lines of the projected capacitive touch panel, the resolution of the projected capacitive touch panel is restricted accordingly. For example, considering the physical characteristics of the projected capacitive touch panel, the size of the diamond-shaped sensing pad of the sensing lines of the projected capacitive touch panel is about 5×5 mm so that an appropriate sensing area is maintained.

Normally, a 3-inch projected capacitive touch panel has 12 x-directional sensing lines and 8 y-directional sensing lines. Thus, under the circumstance that the 3-inch projected capacitive touch panel contains a 12×8 matrix of sensing lines, the projected capacitive touch panel can only return 12×8 coordinate resolution. Such a low resolution can hardly be used in most information products which require high resolution levels.

### SUMMARY OF THE INVENTION

The invention is directed to a coordinate algorithm and a position sensing system of a touch panel. The position of the touched point is obtained by an interpolation algorithm which can be implemented by hardware for increasing the resolution of the touch panel.

According to a first aspect of the present invention, a coordinate algorithm of a touch panel is provided. The coordinate algorithm includes the following steps. On the basis of a default resolution, the range of the x coordinates of multiple x-directional sensing lines and the range of the y coordinates of multiple y-directional sensing lines of the touch panel are determined. When the touch panel is touched, the sensing capacitances of p x-directional sensing lines and q y-directional sensing lines are obtained, wherein the sensing capacitances generated by these sensing lines exceed a threshold, and both p and q are a positive integer. The x central coordinate of the x-directional sensing lines with peak sensing capacitances is taken as an x base coordinate, and the x base coordinate is adjusted according to the ratios of the sensing capacitances of the neighborhood of x-directional sensing lines to the peak sensing capacitance to obtain an interpolated x coordinate. The y central coordinate of the y-directional sensing lines with peak sensing capacitances is taken as a y base coordinate, and the y base coordinate is adjusted according to the ratios of the sensing capacitances of the neighborhood of y-directional sensing lines to the peak sensing capacitance to obtain an interpolated y coordinate.

According to a second aspect of the present invention, a position sensing system of a touch panel is provided. The position sensing system includes a sensing unit and a decision unit. When the touch panel is touched, the sensing unit obtains the sensing capacitances of p x-directional sensing lines and q y-directional sensing lines, wherein the sensing capacitances generated by these sensing lines exceed a threshold, and both p and q are a positive integer. The decision unit takes the central coordinates of the sensing lines with peak sensing capacitances as an x base coordinate and a y base coordinate, and adjusts the x base coordinate and the y base coordinate according to the ratios of the sensing capacitances of the other sensing lines to the peak sensing capacitance respectively to obtain an interpolated x coordinate and an interpolated y coordinate.

According to a third aspect of the present invention, a position sensing system of a touch panel is provided. The position sensing system includes a sensing unit and a decision unit. When the touch panel is touched, the sensing unit obtains the sensing capacitances of p sensing lines, wherein the sensing capacitances generated by the p sensing lines exceed a threshold, and p is a positive integer. The decision unit takes the central coordinate of the sensing lines with peak sensing capacitances as a base coordinate, and adjusts the base coordinate according to the ratios of the sensing capacitances of the other sensing lines to the peak sensing capacitance respectively to obtain an interpolated coordinate.

The invention will become apparent from the following detailed description of the preferred but non-limiting embodiments. The following description is made with reference to the accompanying drawings.

### BRIEF DESCRIPTION OF THE DRAWINGS

FIG. 1 shows a flowchart of a coordinate algorithm of a touch panel according to a preferred embodiment of the invention;

FIG. 2 shows an example of a touch panel according to a preferred embodiment of the invention;

FIG. 3 shows a first example of sensing diagram of a touch panel according to a preferred embodiment of the invention;

FIG. 4 shows a second example of sensing diagram of a touch panel according to a preferred embodiment of the invention;

FIG. 5 shows a third example of sensing diagram of a touch panel according to a preferred embodiment of the invention;

FIG. 6 shows a fourth example of sensing diagram of a touch panel according to a preferred embodiment of the invention;

FIG. 7 shows a fifth example of sensing diagram of a touch panel according to a preferred embodiment of the invention;

FIG. 8A shows a touch motion diagram of sensing lines according to a preferred embodiment of the invention;

FIG. 8B shows a diagram of corrected touch motion of sensing lines according to a preferred embodiment of the invention;

FIG. 9A shows a first example of edge correction according to a preferred embodiment of the invention;

FIG. 9B shows a second example of edge correction according to a preferred embodiment of the invention; and

FIG. 10 shows a display device according to a preferred embodiment of the invention.

### DETAILED DESCRIPTION OF THE INVENTION

The invention provides a coordinate algorithm and a position sensing system of a touch panel. Each neighboring sensing line is divided into several equal intervals, and the central coordinate corresponding to the peak sensing capacitance is taken as a base, and an interpolated coordinate is obtained from the sensing line and its neighboring sensing line so as to obtain the position of the touched point for increasing the resolution of the touch panel. Furthermore, the coordinate algorithm and the sensing system are implementable by hardware.

The invention provides a coordinate algorithm of a touch panel. The coordinate algorithm includes the following steps. The range of the x coordinates of multiple x-directional sensing lines and the range of the y coordinates of multiple y-directional sensing lines of the touch panel are determined on the basis of a default resolution. When the touch panel is touched, the sensing capacitances of p x-directional sensing lines and q y-directional sensing lines are obtained, wherein the sensing capacitances generated by these sensing lines exceed a threshold, and both p and q are a positive integer. The x central coordinate of the x-directional sensing lines with peak sensing capacitances is taken as an x base coordinate, and the x base coordinate is adjusted according to the ratios of the sensing capacitances of the neighborhood of x-directional sensing lines to the peak sensing capacitance to obtain an interpolated x coordinate. The y central coordinate of the y-directional sensing lines with peak sensing capacitances is taken a y base coordinate, and the y base coordinate is adjusted according to the ratios of the sensing capacitances of the neighborhood of y-directional sensing lines to the peak sensing capacitance to obtain an interpolated y coordinate.

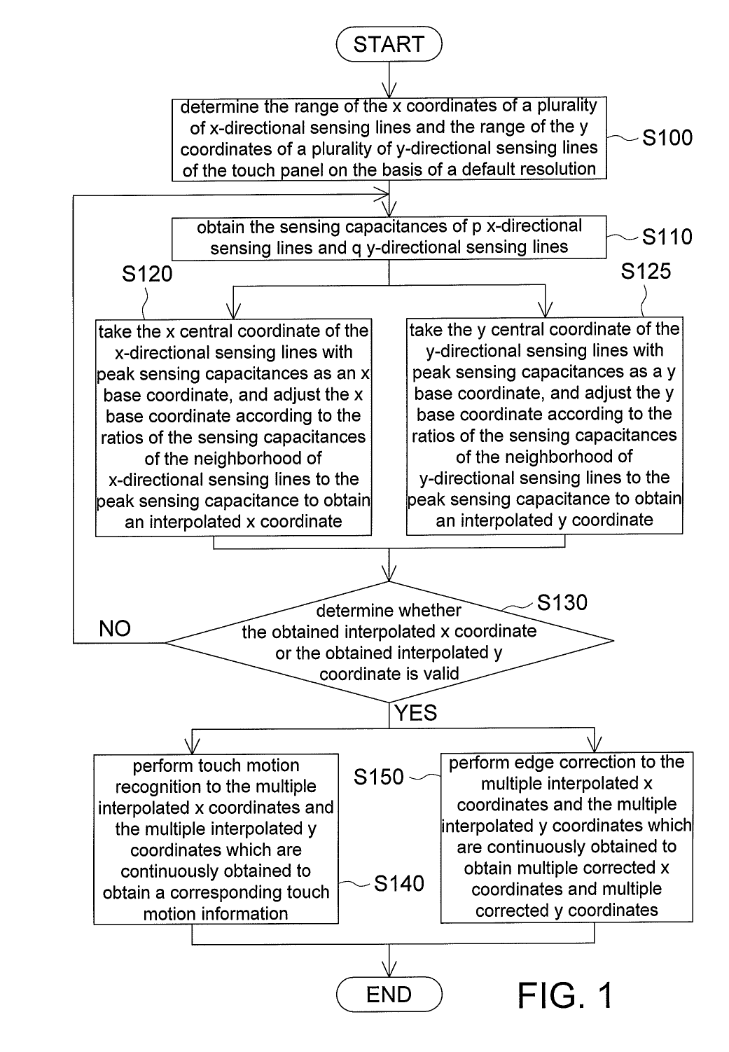

Referring to FIG. 1, a flowchart of a coordinate algorithm of a touch panel according to a preferred embodiment of the invention is shown. The coordinate algorithm disclosed in the present embodiment is used in a touch panel such as a projected capacitive touch panel.

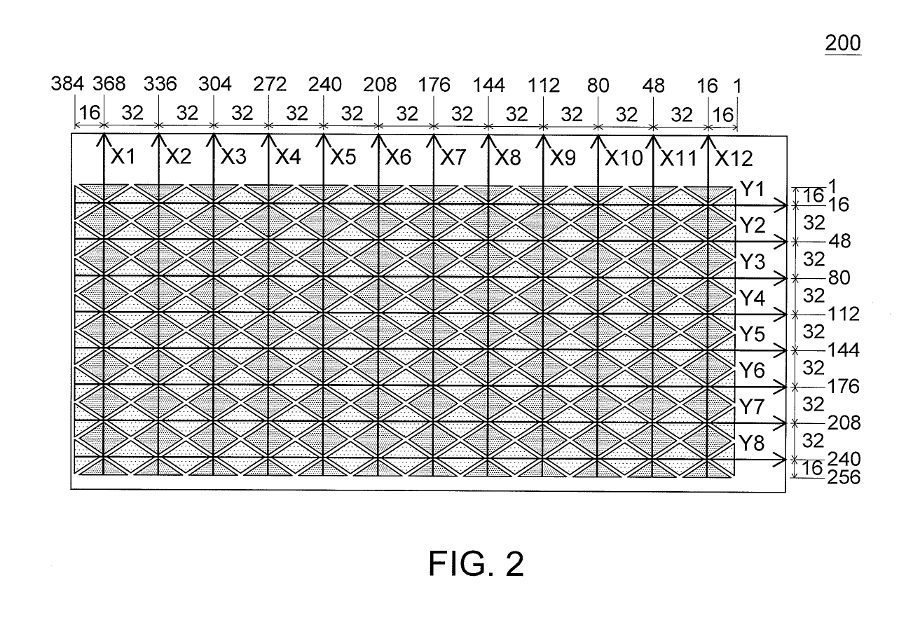

The algorithm begins at step S100, the range of the x coordinates of multiple x-directional sensing lines and the range of the y coordinates of multiple y-directional sensing lines of the touch panel are determined on the basis of a default resolution. Referring to FIG. 2, an example of a touch panel according to a preferred embodiment of the invention is shown. In the following exemplifications, the touch panel is a 3-inch panel, has 12 x-directional sensing lines X1˜X12 and 8 y-directional sensing lines Y1˜Y8, wherein the default resolution is 384×256 for exemplification but is not limited thereto. In FIG. 2, each sensing line of the touch panel 200 has multiple diamond-shaped sensing pads. As the default resolution is 384×256, a 32-order (M-order) x coordinate is differentiated between two neighboring x-directional sensing lines, and a 32-order (N-order) y coordinate is differentiated between two neighboring y-directional sensing lines. For example, the x coordinate of the x-directional sensing line X3 ranges between 288˜320, and the x central coordinate is 304. The y coordinate of the y-directional sensing line Y5 ranges 128˜160, and the y central coordinate is 144.

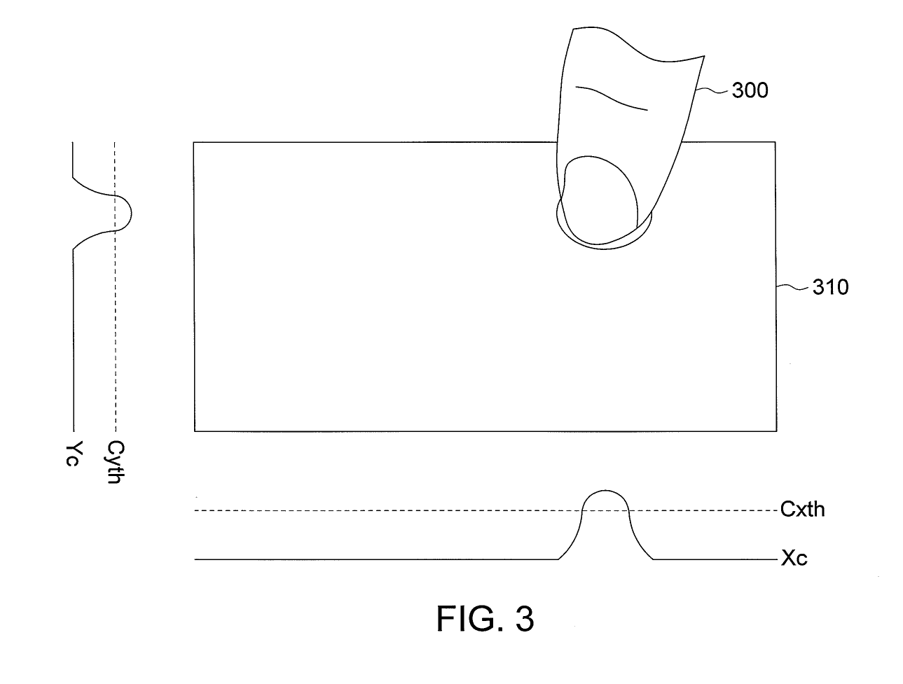

In step S110, when the touch panel is touched, the sensing capacitances of p x-directional sensing lines and q y-directional sensing lines are obtained, wherein the sensing capacitances generated by these sensing lines exceed a threshold, and both p and q are a positive integer. Referring to FIG. 3, a first example of sensing diagram of a touch panel according to a preferred embodiment of the invention is shown. In FIG. 3, when the human body 300 nears the touch panel 310, the capacitances Xc and Yc generated due to the electrostatic coupling between the transparent electrode of the touch panel 310 and the human body 300 increases. Only the sensing lines which generate sensing capacitances exceeding the threshold Cxth and Cyth are selected.

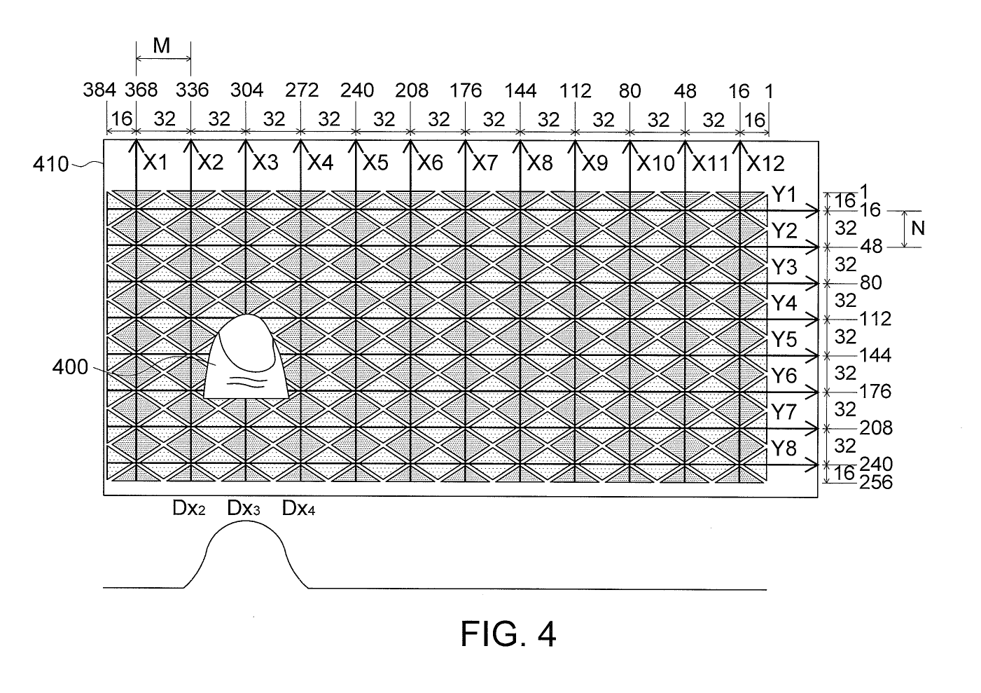

Referring to FIG. 4, a second example of sensing diagram of a touch panel according to a preferred embodiment of the invention is shown. In FIG. 4, when the human body 400 nears the touch panel 410, there are three x-directional sensing lines X2, X3 and X4 generating sensing capacitances exceeding the threshold Cxth, and the sensing capacitances generated by the three x-directional sensing lines X2, X3 and X4 are D_{X2}, D_{X3} and D_{X4} respectively. When the human body 400 nears the touch panel 410, there are three y-directional sensing lines Y4, Y5 and Y6 generating sensing capacitances exceeding the threshold Cyth, and the sensing capacitances generated by the three y-directional sensing lines Y4, Y5 and Y6 are D_{Y4}, D_{Y5} and D_{Y6} respectively.

In step S120, the x central coordinate of the x-directional sensing lines with peak sensing capacitances is taken as an x base coordinate, and the x base coordinate is adjusted according to the ratios of the sensing capacitances of the neighborhood of x-directional sensing lines to the peak sensing capacitance to obtain an interpolated x coordinate. Let the touch panel 400 be taken for example. As indicated in FIG. 4, the x-directional sensing line with peak sensing capacitance is X3, so the peak sensing capacitance is D_{X3}, the x base coordinate, being 304, is the x central coordinate of the x-directional sensing line X3. Then, the x base coordinate 304 is adjusted according to the ratios of the sensing capacitances D_{X2} and D_{X4} of the x-directional sensing lines X2 and X4 to the peak sensing capacitance D_{X3} to obtain an interpolated x coordinate x_{d}. Referring to equation (1):

x_{d}=304+(Dₓ₂/Dₓ₃)×(M/2)−(Dₓ₄/Dₓ₃)×(M/2) (1)

Likewise, in step S125, the y central coordinate of the y-directional sensing lines with peak sensing capacitances is taken as a y base coordinate, and the y base coordinate is adjusted according to the ratios of the sensing capacitances of the neighborhood of y-directional sensing lines to the peak sensing capacitance to obtain an interpolated y coordinate. Let the touch panel 400 be taken for example. As indicated in FIG. 4, the y-directional sensing line with peak sensing capacitance is Y5, so the peak sensing capacitance is D_{Y5}, the y base coordinate, being 144, is the y central coordinate of the y-directional sensing line Y5. Then, the y base coordinate 144 is adjusted according to the ratios of the sensing capacitances of D_{Y4} and D_{Y6} of the y-directional sensing lines Y4 and Y6 to the peak sensing capacitance D_{y5} to obtain an interpolated y coordinate y_{d}. Referring to equation (2):

y_{d}=144+(D_{Y6}/D_{Y5})×(N/2)−(D_{Y4}/D_{Y5})×(N/2) (2)

Thus, under the circumstance that the touch panel 400 contains a 12×8 matrix of sensing lines, the resolution of the touch panel 400 increases to a default resolution level of 384×256. That is, the coordinate algorithm of a touch panel of the invention indeed increases the resolution of the touch panel. Compared with the conventional method of increasing resolution by way of weighted barycenter or numeric data operation which requires complicated add/sub/mul/div and floating-point operations, the coordinate algorithm of the invention obtains an interpolated x coordinate x_{d} and an interpolated y coordinate y_{d} by using simple add add and byte shifting operations. Thus, the coordinate algorithm of the invention is superior to the conventional method in terms of lower complexity of software computing and easier hardware implementation, and further reduces the overall operation time and increase system response rate.

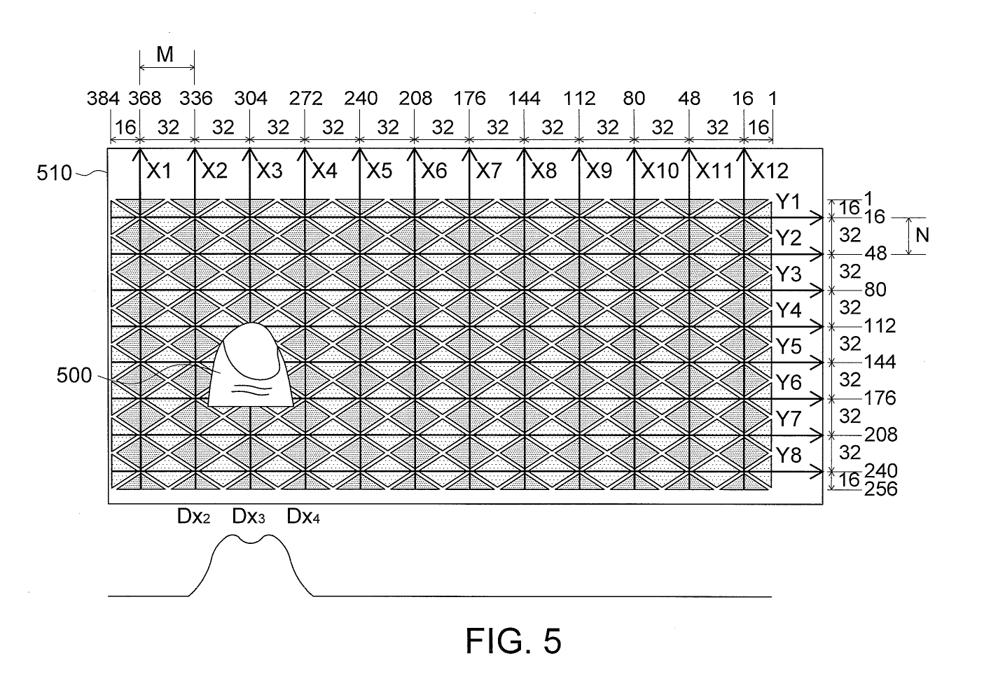

Referring to FIG. 5, a third example of sensing diagram of a touch panel according to a preferred embodiment of the invention is shown. When the human body 500 nears the touch panel 510, there are three x-directional sensing lines X2, X3 and X4 generating sensing capacitances exceeding the threshold Cxth. If the human body 500 contacts the x-directional sensing lines X2, X3 and X4 by the areas of nearly equal size, then the sensing capacitances D_{X2}, D_{X3} and D_{X4} are almost the same. However, the characteristics of resistance-capacitance of the x-directional sensing lines X2, X3 and X4 may be different due to the variation in the manufacturing process, so the sensing capacitances D_{X2}, D_{X3} and D_{X4} are different accordingly.

As indicated in FIG. 5, the sensing capacitance D_{X3} is slightly smaller than the sensing capacitances D_{X2} and D_{X4}. As the x-directional sensing lines X2 and X4 have peak sensing capacitances (D_{X2}=D_{X4}), the x base coordinate, being 304, is the x central coordinate of the x-directional sensing lines X3. Likewise, the same scenario is also applicable to the determination of the y base coordinate of the y-directional sensing lines. Thus, the coordinate algorithm of a touch panel of the invention compensates the inconsistent sensing abilities of the sensing pad caused by the variation in the manufacturing process so as to avoid the bias in position determination and increase the conformity rate of touch panel.

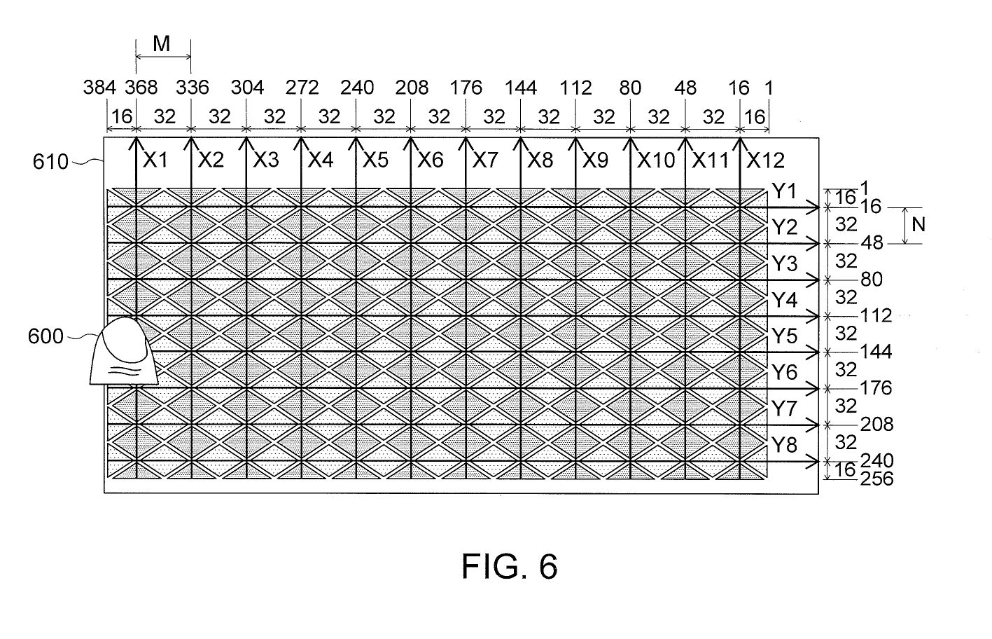

Referring to FIG. 6, a fourth example of sensing diagram of a touch panel according to a preferred embodiment of the invention is shown. When the human body 600 nears the left edge of the touch panel 610, there is only one x-directional sensing line X1 generating sensing capacitance exceeding the threshold Cxth. Under such circumstance, the x base coordinate, being 384, is the x central coordinate of the x-directional sensing line X1, and the x base coordinate, being 384, is adjusted according to the ratios of the sensing capacitance D_{X1} of the x-directional sensing line X1 to a maximum sensing capacitance D_{M} to obtain an interpolated x coordinate x_{d}. Referring to equation (3). The maximum sensing capacitance D_{M} is the sensing capacitance obtained when the human body 600 completely contacts the diamond-shaped sensing pad of the sensing lines. Likewise, the same scenario is also applicable to the y-directional sensing lines.

x_{d}=384−(D_{X1}/D_{M})×(M/2) (3)

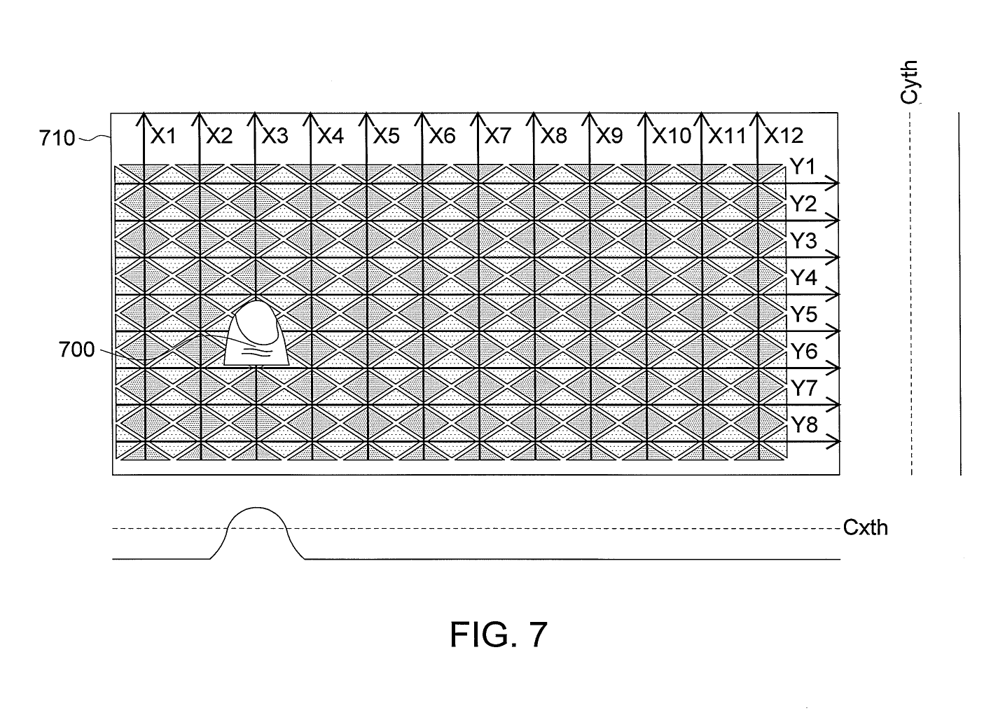

In step S130, whether the obtained interpolated x coordinate or the obtained interpolated y coordinate is valid is determined. Referring to FIG. 7, a fifth example of sensing diagram of a touch panel according to a preferred embodiment of the invention is shown. When the human body 600 nears the touch panel 610, the human body 610 may only contact one single x-directional sensing line or one single y-directional sensing line and thus obtains one single interpolated coordinate. If only the interpolated x coordinate but not the interpolated y coordinate is obtained, or only the interpolated y coordinate but not the interpolated x coordinate is obtained, then the obtained interpolated x coordinate or the obtained interpolated y coordinate is regarded as invalid, otherwise, both the interpolated x coordinate and interpolated y coordinate are regarded as valid.

When the touch point of the touch panel shifts continuously, the coordinate algorithm of a touch panel of the invention obtains multiple interpolated x coordinates and multiple interpolated y coordinates. If both the interpolated x coordinates and the interpolated y coordinates are regarded as valid in step S130, then in step S140, touch motion recognition is performed to the multiple interpolated x coordinates and the multiple interpolated y coordinates which are continuously obtained to obtain a corresponding touch motion information.

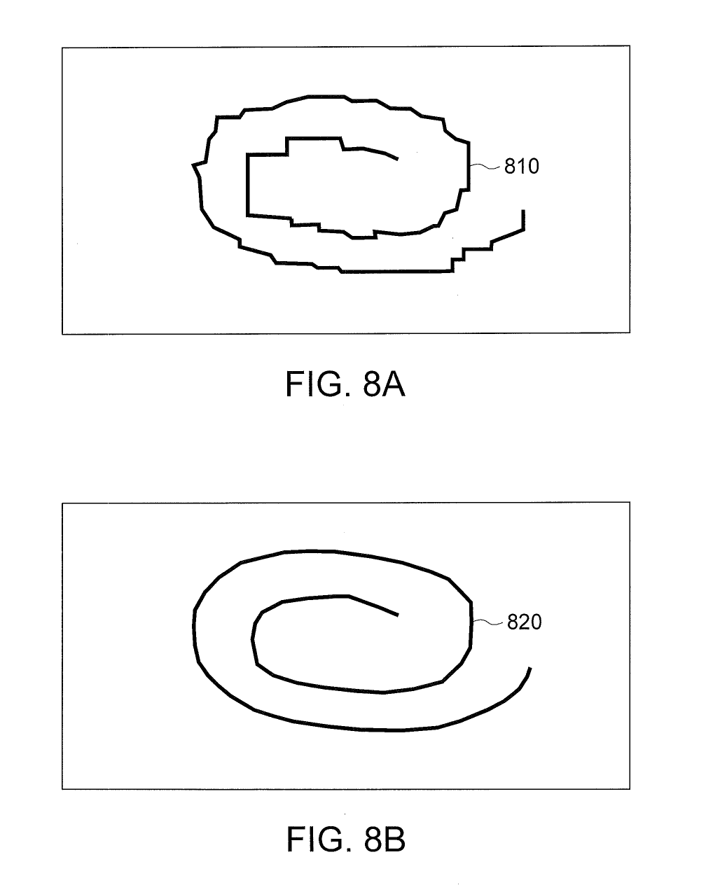

Besides, in the continuous operation mode, the human body nears the diamond-shaped sensing pad of the touch panel but the contact area does not form a linear relationship. Therefore, a multi-order coordinate is differentiated between the x-directional sensing lines and between the y-directional sensing lines as well, and the touch motion of the sensing lines will become zigzag. Referring to FIG. 8A, a touch motion diagram of sensing lines according to a preferred embodiment of the invention is shown. In FIG. 8A, the touch motion 810 is zigzag, not smooth. Thus, when the touch point of the touch panel shifts continuously, the coordinate algorithm of a touch panel of the invention obtains multiple interpolated x coordinates and multiple interpolated y coordinates. If the interpolated x coordinates and the interpolated y coordinate are regarded as valid in step S130, then in step S150, edge correction is performed to the multiple interpolated x coordinates and the multiple interpolated y coordinates which are continuously obtained to obtain multiple corrected x coordinates and multiple corrected y coordinates. Referring to FIG. 8B, a diagram of corrected touch motion of sensing lines according to a preferred embodiment of the invention is shown. In FIG. 8B, the corrected touch motion 820 is smooth.

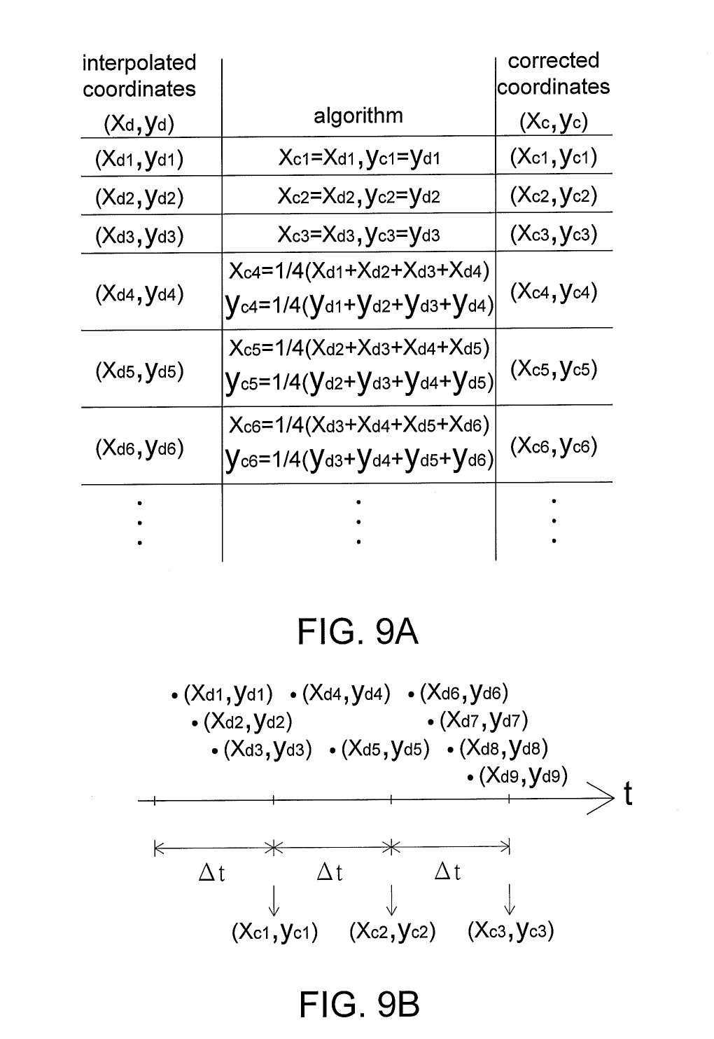

The edge correction of step S150 can be implemented in many ways, and two implementations are disclosed below for exemplification. However, the implementation is not limited to thereto. Referring to FIG. 9A and FIG. 9B. FIG. 9A shows a first example of edge correction according to a preferred embodiment of the invention. FIG. 9B shows a second example of edge correction according to a preferred embodiment of the invention. In FIG. 9A, each interpolated x coordinate and its previous interpolated x coordinate are taken average to obtain a corresponding corrected x coordinate, and each interpolated y coordinate and its previous interpolated y coordinate are taken average to obtain a corresponding corrected y coordinate. For example, the corrected x coordinate x_{c5} corresponding to the interpolated x coordinate x_{d5} is the average of the interpolated x coordinates x_{d2}˜x_{d5}, and the corrected y coordinate y₅ corresponding to the interpolated y coordinate y_{d5} is the average of the interpolated y coordinates y_{d2}˜y_{d5}.

In FIG. 9B, multiple interpolated x coordinates obtained within the fixed time are taken average to obtain a corrected x coordinate, and multiple interpolated y coordinates obtained within the fixed time are taken average to obtain a corresponding corrected y coordinate. For example, the average of the multiple interpolated x coordinates x_{d1}˜x_{d3} within the first fixed time □t corresponds to the corrected x coordinate x_{c1}, and the average of the multiple interpolated y coordinates y_{d1}˜y_{d3} corresponds to the corrected y coordinate y_{c1}. Thus, the digital value converted by the sensing pad of the touch panel is then processed through edge correction to obtain a smooth touch motion close to the feeling of operation by the human body.

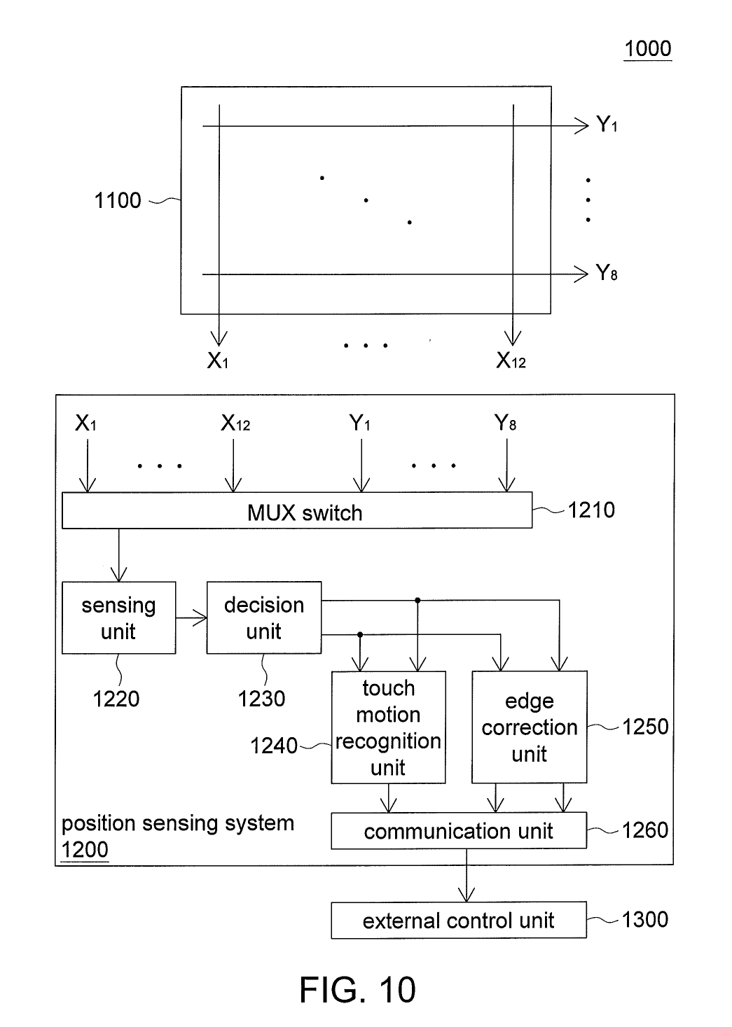

The invention also provides a position sensing system of a touch panel. Referring to FIG. 10, a display device according to a preferred embodiment of the invention is shown. The display device 1000 includes a touch panel 1100, a position sensing system 1200 and an external control unit 1300. The touch panel 1100 includes multiple x-directional sensing lines X1˜X12 and multiple y-directional sensing lines Y1˜Y8. The position sensing system 1200 includes an MUX switch 1210, a sensing unit 1220, a decision unit 1230, a touch motion recognition unit 1240, an edge correction unit 1250 and a communication unit 1260. The MUX switch 1210 is coupled to the multiple x-directional sensing lines X1˜X12 and the multiple y-directional sensing lines Y1˜Y8 for receiving signals.

When the touch panel 1100 is touched, the sensing unit 1220 obtains the sensing capacitances of p x-directional sensing lines and q y-directional sensing lines, wherein the sensing capacitances generated by these sensing lines exceed a threshold. The decision unit 1230 takes the central coordinates of the sensing lines with peak sensing capacitances as an x base coordinate and a y base coordinate, and adjusts the x base coordinate and the y base coordinate according to the ratios of the sensing capacitances of the other sensing lines to the peak sensing capacitance respectively to obtain an interpolated x coordinate x_{d} and an interpolated y coordinate y_{d}. The principles of operation of the sensing unit 1220 and the decision unit 1230 are similar to that indicated in FIG. 1˜FIG. 6, and are not repeated here.

When the touch point of the touch panel 1100 shifts continuously, the decision unit 1230 obtains multiple interpolated x coordinates x_{d} and multiple interpolated y coordinates y_{d}. If the decision unit 1230 regards the interpolated x coordinates x_{d} and the interpolated y coordinate y_{d} as valid, then the touch motion recognition circuit 1240 performs touch motion recognition to the interpolated x coordinate x_{d} and the interpolated y coordinate y_{d} to obtain a corresponding touch motion information. Besides, the edge correction unit 1250 also performs edge correction to the interpolated x coordinate x_{d} and the interpolated y coordinate y_{d} to obtain multiple corrected x coordinates x_{c} and multiple corrected y coordinates y_{c}. The edge correction unit 1250 can adopt the implementation indicated in FIG. 9A and FIG. 9B but is not limited thereto.

The communication unit 1260 being the communication channel between the position sensing system 1200 and the external control unit 1300 is capable of transmitting the touch motion information outputted from the touch motion recognition circuit 1240 and the corrected x coordinates x_{c} as well as the corrected y coordinates y_{c} outputted from the edge correction unit 1250 to the external control unit 1300 and receiving the commands transmitted from the external control unit 1300.

The coordinate algorithm and the position sensing system of a touch panel disclosed in the above embodiments of the invention have many advantages exemplified below:

According to the coordinate algorithm and the position sensing system of a touch panel disclosed in the invention, each sensing line is divided into several interpolated intervals of equal distance, and the central coordinate corresponding to the peak sensing capacitance is taken as a base, and an interpolated coordinate is obtained from the sensing line and its neighboring sensing line so as to obtain the position of the touched point for increasing the resolution of the touch panel. Furthermore, the coordinate algorithm and the sensing system are implementable by hardware. Besides, the coordinate algorithm of the invention adopts simple operation and is thus advantageous in terms of lower complexity of software computing and easier hardware implementation, and further reduces the overall operation time and increase system response rate. Moreover, the coordinate algorithm of a touch panel of the invention compensates the inconsistent sensing abilities of the sensing pad caused by the variation in the manufacturing process so as to avoid the bias in position determination and increase the conformity rate of touch panel.

Besides, the coordinate algorithm and the position sensing system of the invention performs edge correction to the obtained interpolated coordinate to resolve the problem of zigzag touch motion of sensing lines which occurs during the continuous operation mode when the human body nears the diamond-shaped sensing pad of the touch panel and the contact area does not form a linear relationship. Thus, the digital value converted by the sensing pad of the touch panel is then processed through edge correction to obtain a smooth touch motion close to the feeling of operation by the human body.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A coordinate algorithm of a touch panel, comprising:
determining the range of the x coordinates of a plurality of x-directional sensing lines and the range of the y coordinates of a plurality of y-directional sensing lines of the touch panel on the basis of a default resolution;
obtaining the sensing capacitances of p x-directional sensing lines and q y-directional sensing lines when the touch panel is touched, wherein the sensing capacitances generated by these sensing lines exceed a threshold, and both p and q are a positive integer;
taking the x central coordinate of the x-directional sensing lines with peak sensing capacitances as an x base coordinate, and adjusting the x base coordinate according to the ratios of the sensing capacitances of the other (p−1) x-directional sensing lines to the peak sensing capacitance to obtain an interpolated x coordinate; and
taking the y central coordinate of the y-directional sensing lines with peak sensing capacitances as a y base coordinate, and adjusting the y base coordinate according to the ratios of the sensing capacitances of the other (q−1) y-directional sensing lines to the peak sensing capacitance to obtain an interpolated y coordinate.

2. The coordinate algorithm of a touch panel according to claim 1, wherein an M-order x coordinate is interpolated between two neighboring x-directional sensing lines, an N-order y coordinate is interpolated between two neighboring y-directional sensing lines, and both M and N are a positive integer.

3. The coordinate algorithm of a touch panel according to claim 1, wherein if two x-directional sensing lines have the peak sensing capacitance and the sensing capacitance of the x-directional sensing line between the two x-directional sensing lines is slightly smaller than the peak sensing capacitance, then the x central coordinate of the x-directional sensing lines with a slightly smaller sensing capacitance is taken as the x base coordinate, and if two y-directional sensing lines have the peak sensing capacitance and the sensing capacitance of the y-directional sensing line between the two y-directional sensing lines is slightly smaller than the peak sensing capacitance, then the y central coordinate of the y-directional sensing lines with a slightly smaller sensing capacitance is taken as the y base coordinate.

4. The coordinate algorithm of a touch panel according to claim 1, if only one single x-directional sensing line generates sensing capacitances exceeding the threshold, then the x central coordinate of the x-directional sensing lines is taken as the x base coordinate, and the x base coordinate is adjusted according to the ratios of the sensing capacitances of the x-directional sensing lines to a maximum sensing capacitance to obtain the interpolated x coordinate.

5. The coordinate algorithm of a touch panel according to claim 1, if only one single y-directional sensing line generates sensing capacitances exceeding the threshold, then the y central coordinate of the y-directional sensing lines is taken as the y base coordinate, and the y base coordinate is adjusted according to the ratios of the sensing capacitances of the y-directional sensing lines to a maximum sensing capacitance to obtain the interpolated y coordinate.

6. The coordinate algorithm of a touch panel according to claim 1, wherein when the touch panel is touched, if only the interpolated x coordinate is obtained but not the interpolated y coordinate or only the interpolated y coordinate is obtained but not the interpolated x coordinate, then only the obtained interpolated x coordinate or the obtained interpolated y coordinate is regarded as invalid, otherwise, both the interpolated x coordinate and the interpolated y coordinate are regarded as valid.

7. The coordinate algorithm of a touch panel according to claim 6, further comprising:
obtaining a plurality of interpolated x coordinates and a plurality of interpolated y coordinates when the touch point of the touch panel shifts continuously; and
performing edge correction to the interpolated x coordinates and the interpolated y coordinates to obtain a plurality of corrected x coordinates and a plurality of corrected y coordinates if the interpolated x coordinates and the interpolated y coordinates are regarded as valid.

8. The coordinate algorithm of a touch panel according to claim 7, wherein one of the interpolated x coordinates and its previous interpolated x coordinate are taken average to obtain the corresponding corrected x coordinates, and one of the interpolated y coordinates and its previous interpolated y coordinate are taken average to obtain the corresponding corrected y coordinate.

9. The coordinate algorithm of a touch panel according to claim 7, wherein the interpolated x coordinates obtained within a fixed time are taken average to obtain the corresponding corrected x coordinate, and the interpolated y coordinates obtained within the fixed time are taken average to obtain the corresponding corrected y coordinate.

10. The coordinate algorithm of a touch panel according to claim 6, further comprising:
obtaining a plurality of interpolated x coordinate and a plurality of interpolated y coordinate when the touch point of the touch panel shifts continuously; and
performing touch motion recognition to the interpolated x coordinates and the interpolated y coordinates to obtain corresponding touch motion information if the interpolated x coordinates and the interpolated y coordinates are regarded as valid.

11. A position sensing system of a touch panel, comprising:
a sensing unit used for obtaining the sensing capacitances of p x-directional sensing lines and q y-directional sensing lines when the touch panel is touched, wherein the sensing capacitances generated by these sensing lines exceed a threshold, and both p and q are a positive integer; and
a decision unit used for taking the central coordinates of the sensing lines with peak sensing capacitances as an x base coordinate and a y base coordinate, and adjusting the x base coordinate and the y base coordinate according to the ratios of the sensing capacitances of the other sensing lines to the peak sensing capacitance respectively to obtain an interpolated x coordinate and an interpolated y coordinate.

12. The position sensing system of a touch panel according to claim 11, wherein the sensing unit determines the range of the x coordinate of each x-directional sensing line and the range of the y coordinate of each y-directional sensing line of the touch panel on the basis of a default resolution.

13. The position sensing system of a touch panel according to claim 12, wherein the sensing unit differentiates an M-order x coordinate between two neighboring x-directional sensing lines and differentiates an N-order y coordinate between two neighboring y-directional sensing lines, and both M and N are a positive integer.

14. The position sensing system of a touch panel according to claim 11, wherein the decision unit takes the x central coordinate of the x-directional sensing lines with peak sensing capacitances as the x base coordinate, and adjusts the x base coordinate according to the ratios of the sensing capacitances of the other (p−1) x-directional sensing lines to the peak sensing capacitance to obtain the interpolated x coordinate, and further takes the y central coordinate of the y-directional sensing lines with peak sensing capacitances as the y base coordinate and adjusts the y base coordinate according to the ratios of the sensing capacitances of the other (q−1) y-directional sensing lines to the peak sensing capacitance to obtain the interpolated y coordinate.

15. The position sensing system of a touch panel according to claim 14, if two x-directional sensing lines have the peak sensing capacitance and the sensing capacitance of the x-directional sensing line between the two x-directional sensing lines is slightly smaller than the peak sensing capacitance, then the decision unit takes the x central coordinate of the x-directional sensing lines with a slightly smaller sensing capacitance as the x base coordinate, and if two y-directional sensing lines have the peak sensing capacitances and the sensing capacitance of the y-directional sensing line between the two y-directional sensing lines is slightly smaller than the peak sensing capacitance, then the decision unit takes the y central coordinate of the y-directional sensing lines with a slightly smaller sensing capacitance as the y base coordinate.

16. The position sensing system of a touch panel according to claim 14, wherein if only one single x-directional sensing line generates sensing capacitances exceeding the threshold, then the decision unit takes the x central coordinate of the x-directional sensing lines as the x base coordinate, and adjusts the x base coordinate according to the ratios of the sensing capacitances of the x-directional sensing lines to a maximum sensing capacitance to obtain the interpolated x coordinate.

17. The position sensing system of a touch panel according to claim 14, wherein if only one single y-directional sensing line generates sensing capacitances exceeding the threshold, then the decision unit takes the y central coordinate of the y-directional sensing lines as the y base coordinate, and adjusts the y base coordinate according to the ratios of the sensing capacitances of the y-directional sensing lines to a maximum sensing capacitance to obtain the interpolated y coordinate.

18. The position sensing system of a touch panel according to claim 14, wherein when the touch panel is touched, if the decision unit only obtains the interpolated x coordinate but not the interpolated y coordinate or only obtains the interpolated y coordinate but not the interpolated x coordinate, then the decision unit only regards the obtained interpolated x coordinate or the obtained interpolated y coordinate as invalid, otherwise, the decision unit regards both the interpolated x coordinate and the interpolated y coordinate as valid.

19. The position sensing system of a touch panel according to claim 18, wherein the decision unit obtains a plurality of interpolated x coordinate and a plurality of interpolated y coordinate when the touch point of the touch panel shifts continuously, and the position sensing system further comprises:
an edge correction unit used for performing edge correction to the interpolated x coordinates and the interpolated y coordinates to obtain a plurality of corrected x coordinates and a plurality of corrected y coordinates both when both the interpolated x coordinates and the interpolated y coordinates are regarded as valid.

20. The position sensing system of a touch panel according to claim 19, wherein the edge correction unit takes average of one of the interpolated x coordinates and its previous interpolated x coordinate to obtain the corresponding corrected x coordinate, and takes average of one of the interpolated y coordinates and its previous interpolated y coordinate to obtain the corresponding corrected y coordinate.

21. The position sensing system of a touch panel according to claim 19, wherein the edge correction unit takes average of the interpolated x coordinates obtained within a fixed time to obtain the corresponding corrected x coordinate, and takes average of the interpolated y coordinates obtained within the fixed time to obtain the corresponding corrected y coordinate.

22. The position sensing system of a touch panel according to claim 18, wherein the decision unit obtains a plurality of interpolated x coordinate and a plurality of interpolated y coordinate when the touch point of the touch panel shifts continuously, and the position sensing system further comprises:
a touch motion recognition circuit used for performing touch motion recognition to the interpolated x coordinates and the interpolated y coordinates to obtain corresponding touch motion information when both the interpolated x coordinates and the interpolated y coordinates are regarded as valid.

23. A position sensing system of a touch panel, comprising:
a sensing unit used for obtaining the sensing capacitances of p sensing lines when the touch panel is touched, wherein the sensing capacitances generated by the p sensing lines exceed a threshold, and p is a positive integer; and
a decision unit used for taking the central coordinate of the sensing lines with peak sensing capacitances as a base coordinate, and adjusting the base coordinate according to the ratios of the sensing capacitances of the other sensing lines to the peak sensing capacitance respectively to obtain an interpolated coordinate.

24. The position sensing system of a touch panel according to claim 23, wherein the decision unit takes the central coordinate of the sensing lines with peak sensing capacitances as the base coordinate, and adjusts the base coordinate according to the ratios of the sensing capacitances of the other (p−1) sensing lines to the peak sensing capacitance to obtain the interpolated coordinate.
